(19) United States
(12) Patent Application Publication
(10) Pub. No.: US 2012/0023041 A1
(43) Pub. Date: Jan. 26, 2012

(54) SYSTEM AND METHOD FOR PREDICTIVE NETWORK MONITORING

(76) Inventors: Yoram Kariv, Tel Aviv (IL); Mark Zlochin, Givataim (IL); Ofer Shemesh, Givat-Shmuel (IL)

(21) Appl. No.: 12/672,520

(22) PCT Filed: Aug. 6, 2008
(86) PCT No.: PCT/IL08/01076

§ 371 Date: Feb. 8, 2010

Related U.S. Application Data
(60) Provisional application No. 60/954,601, filed on Aug. 8, 2007.

(51) Int. Cl. G06F 15/18; G06F 17/50

(52) U.S. Cl. 706/12; 703/13

(57) ABSTRACT

A system and a method for at least predicting a trend toward a reduction in performance of a computer and/or a computer network. Preferably, the system and method is able to predict a trend toward a potential failure of a computer and/or a computer network.

### FIELD OF THE INVENTION

The present invention relates to a system and a method for predictive monitoring of a network, such as a computer network, and in particular, to such a system and method which enable the behavior of the network to be analyzed in order to detect a potential reduction in operational efficacy.

### BACKGROUND OF THE INVENTION

Computers and information technology (IT) has become an indispensable part of business activities as well as daily life. Reliable operation of computers and their corresponding networks has therefore become increasingly important. Yet the rapidly expanding role of computers and computer networks, and their increased complexity, has made it more difficult to provide smooth, uninterrupted, reliable service. Computer failure may contribute to computer network failure; however, often the problem relates to an unexpected and unknown reduction in computer performance and/or performance of the network. The reduction is also often unpredictable, as it may occur even when one or more computers, and/or the network itself, are not apparently experiencing a peak load or overload of activity.

Various solutions have been proposed for such mysterious failures or reductions in performance; however, they all suffer from the drawback that they fail to predict a potential failure or reduction in performance in advance; in fact they cannot even predict a trend toward such failure or reduction in performance. Furthermore these systems cannot provide real time information at the initial stage or stages of a problematic situation. These systems provide information only after detecting the existence of the problem and thus, in many cases are not able to analyze the source of the problem.

Simply increasing computing power devoted to such analysis is not helpful, particularly since the failures and/or reductions in performance are typically relatively rare events (occurring 1-2% of computing hours) although they can be devastating. Also, adding more than one analysis method is also not itself helpful, since existing multi-expert methods, such as boosting and ensemble learning, are known to perform badly when presented with rare events.

### SUMMARY OF THE INVENTION

There is an unmet need for, and it would be highly useful to have, a system and a method for at least predicting a trend toward a reduction in performance of a computer and/or a computer network and that preferably also provides information about the system when such a trend is predicted. There is also an unmet need for, and it would be highly useful to have, a system and a method for at least predicting a trend toward a potential failure of a computer and/or a computer network and that preferably also provides is information about the system when such a failure is predicted.

There is also an unmet need for, and it would be highly useful to have, such a system and method which could learn from previous attempts at predicting at least a trend toward a reduction in performance and/or failure and which could correspondingly improve in predictive ability.

The present invention overcomes these deficiencies of the background art by providing a system and method for at least predicting a trend toward a reduction in performance of a computer and/or a computer network and preferably providing information about the system when such a trend is predicted. Preferably, the system and method is able to predict a trend toward a potential failure of a computer and/or a computer network and thus, by providing information about the system when the trend occurs enables a better analysis of the cause of the trend.

Optionally and preferably, the system and method of the present invention are able to predict such a trend through monitoring the performance of the computer network. More preferably, such monitoring is performed non-invasively. Most preferably, such non-invasive monitoring is performed through a computer on the network but without invasively monitoring all computers on the network, thereby obviating the need for installing agents on the computers of the network. Monitoring the system without invasively monitoring all computers on the network is done, for example, by accessing existing system parameters or by retrieving the information from third party monitoring systems such as Unicenter CA, Tivoli and the like.

Also optionally and preferably, the prediction of at least the trend is performed by modeling at least one aspect of the performance of the computer network. More preferably at least one aspect of the performance of at least one computer on the computer network is modeled; such an aspect can optionally be, for example, response time. Alternatively a combination of one or more aspects can be modeled. Such modeling preferably includes at least one adjustment to a model which is determined at least partially is according to past performance of the computer network and past predictive ability of the model. This method is preferably done through a multi expert learning architecture, described hereinafter. The adjustment may also optionally and preferably be performed according to existing expert knowledge about the computer network, most preferably according to such knowledge about at least one of the structure of the computer network, past performance of the network and/or a known weak point of the computer network (i.e., an aspect of the network which was previously determined to be problematic or potentially problematic or possibly problematic), and/or about a computer on the network. Optionally and preferably, such previous knowledge of the network is analyzed and is incorporated into the model; however, optionally non-relevant data is not incorporated, such that the analysis does not necessarily result in the inclusion of all data to the model.

According to other embodiments of the present invention, the system and method include a filter for filtering data obtained for monitoring according to relevancy thereof. Such filtering criteria can be for example correlation with the performance metrics. The filter may optionally rank or prioritize the data, and/or may alternatively (or additionally) act as a cut-off to remove non-relevant data.

According to yet other embodiments of the present invention, the system and method is able to predict a reduction in performance of a computer and/or a computer network, through the statistical learning procedure described hereinafter. Preferably, the system and method are able to predict a potential failure thereof.

Optionally and preferably, the reduction in performance and/or failure is a rare event, occurring in less than about 10% of computing hours, more preferably occurring in less than about 5% of computing hours and most preferably occurring in less than about 3% of computing hours (preferably calculated for all computers being so monitored).

According to still other embodiments of the present invention, the system and method are optionally and preferably flexible with regard to a is relative ratio of precision and sensitivity. More preferably, the ratio is adjustable according to at least one parameter. Most preferably, the at least one parameter is determined according to a user preference. Optionally, the at least one parameter is determined by setting a threshold for false positive predictions of reduction in performance and/or failure and issuing an alarm when a predicted value exceeds a threshold. The threshold is preferably determined so as to avoid false positives. Optionally the user may adjust the threshold, as a lower threshold provides greater sensitivity while a higher threshold is more likely to avoid false positives. Also, optionally the threshold is adjusted according to a particular computer and/or other part or component of the network. The threshold may also optionally be determined differently according to the time of day, day of the week, time of the year and so forth. For example a lower threshold which provides higher sensitivity might be adjusted for the night time or for any time of day that is predicted to have a lower level of traffic on the network. A combination of these various factors may also optionally be used to determine the threshold.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating is system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a schematic block diagram of an exemplary, illustrative system according to some embodiments of the present invention;

FIG. 2 shows a schematic block diagram of an exemplary, illustrative monitor and predictor from the system of FIG. 1 according to some embodiments of the present invention in more detail;

FIG. 3 is a schematic block diagram of an exemplary, illustrative hierarchical predictive system according to some embodiments of the present invention;

FIG. 4 shows an exemplary, illustrative method according to some embodiments of the present invention for the function of a pruning operator;

FIG. 5 is an exemplary scenario of system real time behavior;

FIG. 6 is an exemplary description of learning process; and

FIG. 7 is an exemplary scenario which illustrates the importance and benefits of the system.

### DESCRIPTION OF THE PREFERRED EMBODIMENTS

The present invention is of a system and a method for at least predicting a trend toward a reduction in performance of a computer and/or a computer network. Preferably, the system and method is able to predict a trend toward a potential failure of a computer and/or a computer network.

Optionally and preferably, the system and method of the present invention are able to predict such a trend through monitoring the performance of the computer network and specifically through statistical modeling of the monitored performance. More preferably, such monitoring is performed non-invasively. Most preferably, such non-invasive monitoring is performed through a computer on the network but without invasively monitoring all computers on the network, thereby obviating the need for installing agents on the computers of the network.

Also optionally and preferably, the prediction of at least the trend is is performed by modeling at least one aspect of the performance of the computer network. More preferably at least one aspect of the performance of at least one computer on the computer network is modeled. Such modeling preferably includes at least one adjustment to a model which is determined at least partially according to past performance of the computer network and past predictive ability of the model. The adjustment may also optionally and preferably be performed according to existing expert knowledge about the computer network, most preferably according to such knowledge about at least one of the structure of the computer network, past performance of the network and/or a known weak point of the computer network, and/or about a computer on the network.

According to preferred embodiments of the present invention, the modeling is adjusted at least once within a period of time according to the behavior of the computer network. Such adjustment(s) are preferably performed through the meta-analyzer, described hereinafter, which is optionally activated at intervals and evaluates the prediction accuracy during each interval; the meta-analyzer may optionally make an adjustment, if needed.

Also according to preferred embodiments of the present invention, upon installation of the system and method to a computer network, the model is determined at least partially according to available data about the behavior of the computer network. Such data can be retrieved, for example from historical system data logs. Optionally and preferably, the model is also determined according to external information about the computer network, more preferably related to the structure of the network and most preferably related to at least one aspect of a weakness of the network. Such aspects can be, for example, memory bottlenecks for IBM CICS and the like. The external information preferably comprises expert knowledge concerning the critical performance metrics and the one or more variables that may optionally be relevant for prediction purposes. The available data may is optionally comprise data relating to behavior of the computer network over a short period of time, for example from a few hours to a few days to a few weeks. Such data can be, for example CPU load, memory, database performance, transaction rate and the like.

The model is then preferably updated according to at least one new data input related to the performance of the computer network and is more preferably updated incrementally according to a plurality of data inputs. More preferably, if the computer network exhibits non-stationary behavior which is changing over time, the model is updated to reflect such non-stationary (dynamic) behavior. The prediction component or predictor preferably reviews data, and then updates the model according to any changes in the behavior of the network or a component or part thereof.

Optionally and preferably, the system of the present invention features a plurality of models, organized into a hierarchy in which all models are preferably combined by an expert controller or meta-expert. Each model preferably operates independently; however, the models are preferably combined by an expert controller or meta-expert, which determines the final prediction. Each model is optionally adjusted separately according to at least one data input and preferably according to at least one learning algorithm, as described in greater detail below. However, the learning period is preferably separate from real time operation and is used for ranking the predictors according to their performance. Predictor performance is preferably ranked according to comparison of predicted values to real, actually obtained values.

Optionally and preferably, at run time, all of the models receive the same or at least similar data, such that the meta-expert preferably combines a plurality of different models that were constructed on the basis of the same or at least similar data, yet which provide different predictions. Most preferably, the final prediction of the system is obtained by incrementally learning the optimal combination rule for the individual models, such that the final prediction is most preferably a synergistic combination of the predictions of the plurality of models. This is optionally and preferably done by a top level is controller, which is also referred to as the meta-expert.

More preferably the meta-expert operates by synthesizing the plurality of predictions models according to one or more combination rules, for example weighted average, weighted median or any other combination rules. For combination rules which involve weighting, each model is preferably assigned a weight, during the learning phase, which relates to the relative accuracy of the model.

The combined output is then preferably analyzed according to a threshold in order to determine the model of the performance of the computer network. The threshold is more preferably related to the predictive performance of the model.

If the model fails to meet the threshold of predictive performance, then optionally and preferably a new model is created. The new model is preferably trained on additional data regarding the performance of the computer network, more preferably at least partially guided according to at least one aspect of the model featuring a lower accuracy. For example, such guidance may optionally be provided by augmenting the additional data and/or previous data with weights, more preferably for focusing on the feature-space regions of the model in which the accuracy is low.

Optionally and most preferably, the above process is repeated when the model fails to provide a sufficient level of predictive accuracy.

In order to keep the number of models in the hierarchy below a maximum number, preferably at least one pruning operator is operated to remove at least one model that is not required. More preferably, the pruning operates removes at least one model having a lower level of accuracy and most preferably removes all models having a level of accuracy that is below a minimum threshold. Optionally and most preferably, all models are removed for which such removal does not reduce the precision and recall of the system, for example in order to increase efficiency of operation of the predictive model.

The principles and operation of the present invention may be better is understood with reference to the drawings and the accompanying description.

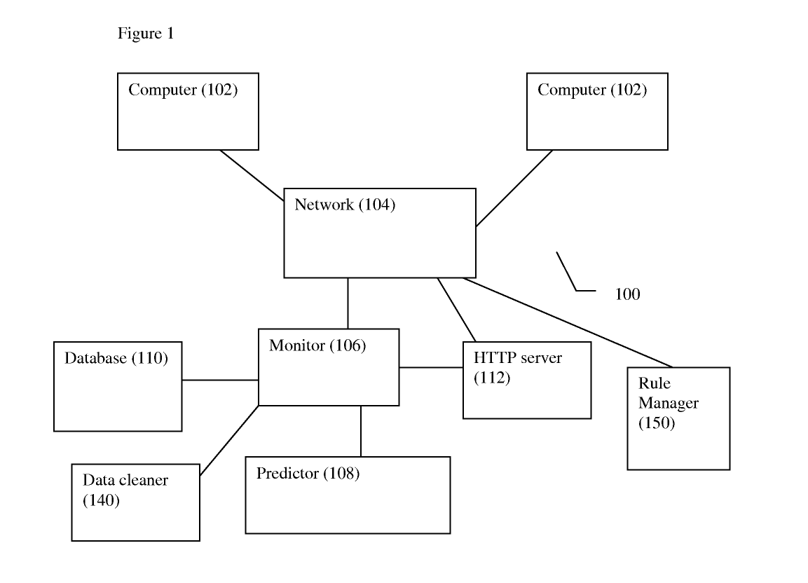

Referring now to the drawings, FIG. 1 shows a schematic block diagram of an exemplary, illustrative system according to some embodiments of the present invention. As shown, in a system 100, a plurality of computers 102 are connected through a computer network 104. Computer network 104 may optionally be implemented as is known in the art for any such network structure and may optionally have various configurations of computers 102, also as is known in the art

Computer network 104 is also optionally and preferably connected to a monitor 106 according to the present invention. Monitor 106 optionally and preferably monitors the performance of computer network 104, by more preferably monitoring the behavior of at least one computer 102 but more preferably of a plurality of computers 102 thereof. Such monitoring is preferably performed in a non-invasive manner, as evidenced by the separate position of monitor 106 on network 104, such that monitor 106 preferably does not feature an agent installed at each computer 102 for example. Instead, monitor 106 is optionally and preferably able to gather data regarding the behavior and/or performance of computers 102 on network 104 by interacting with one or more computers 102, for example by querying one or more computers 102 or by interacting with a third party monitoring system (not shown). Gathering the data is optionally and preferably performed by using a common API (application programming interface) for a third party monitoring application, or through a proprietary API for specific systems, for example a proprietary API for a third party monitoring system. Alternatively or additionally, monitor 106 is able to gather data by listening on computer network 104, for example to a plurality of communications between computers 102.

The performance data, such as memory utilization, resources utilization, disk utilization and the like which is gathered by monitor 106 is preferably then passed to a data cleaner 140 for filtering out the noise in the is collected data. Data from data cleaner 140 is then transferred to at least one predictor 108, for predicting at least a trend of performance of computer network 104 and/or a plurality of computers 102. Predictor 108 more preferably is able to predict the performance of computer network 104 and/or a plurality of computers 102, and most preferably is able to predict a potential failure of computer network 104 and/or a plurality of computers 102.

Predictor 108 optionally and preferably increases accuracy of prediction through repeated analysis of the performance of computer network 104 and/or a plurality of computers 102, for example through repeated analysis of the behavior of computer network 104 and/or a plurality of computers 102 during the learning phase. Optionally, predictor 108 features a plurality of expert predictors (modules) (not shown), which may optionally be replaced if they are not accurate.

Predictor 108 optionally comprises part of monitor 106 or alternatively may be separate from monitor 106. If separate, predictor 108 optionally communicates with monitor 106, for example to receive data from monitor 106, through computer network 104. Alternatively, predictor 108 may communicate directly with monitor 106 as shown, for example by installed on a single computer (not shown).

System 100 may also optionally and preferably feature a database 110 for storing performance and configuration data, prediction of future events and the like; alternatively each of predictor 108 and monitor 106 may have a separate database (not shown).

System 100 may also optionally feature a HTTP server 112 for providing HTTP communications for a user interface, such as a web-based user interface for example (not shown), preferably for providing interactions and/or information to/from predictor 108 and/or monitor 106. Such information can be, for example and without limitation, graphs, alerts, collected data, configuration information and the like. Without wishing to be limited, such a configuration is preferred (but not absolutely required) for security reasons for example. Parameters regarding predicting intervals, thresholds for generating alarms and the like are configured in the rule manager 150.

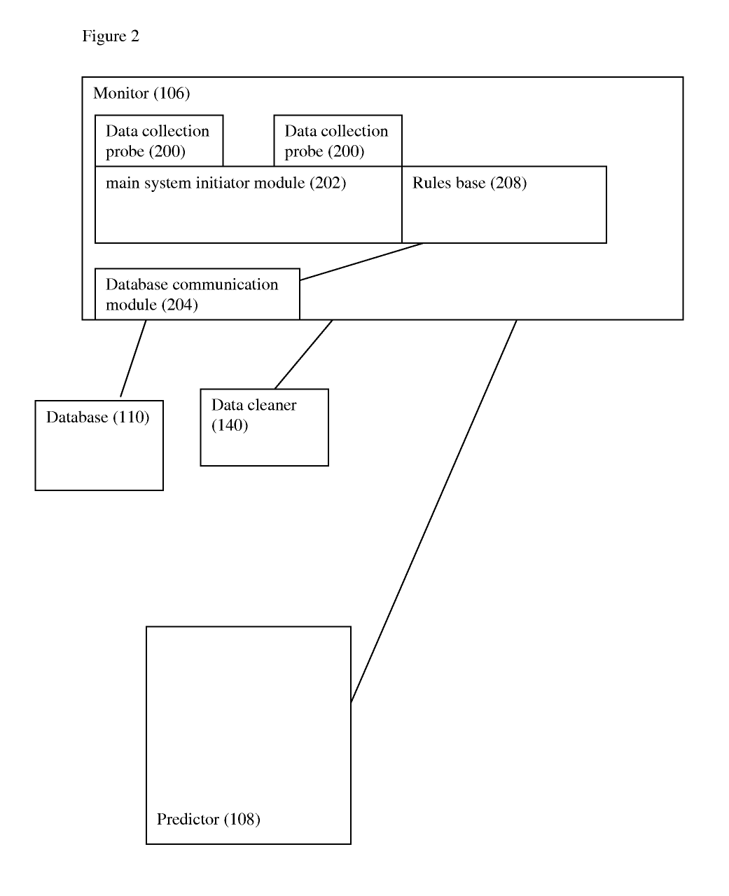

FIG. 2 shows a schematic block diagram of an exemplary, illustrative monitor and predictor from the system of FIG. 1 according to some embodiments of the present invention in more detail.

As shown, monitor 106 optionally and preferably comprises a plurality of data collection probes 200 for collecting data. Although data collection probes 200 are shown in a preferred configuration as part of monitor 106, in fact data collection probes 200 could optionally be installed on network 104, preferably at a plurality of locations (not shown).

Data collection probes 200 optionally and preferably passively listen to network 104 by receiving events, but more preferably actively receive information from computers 102 by optionally and preferably polling the computers (not shown; see FIG. 1). Such information can be, for example memory usage, CPU usage and the like. Data collection probe 200 optionally and preferably retrieves information which is unique for the type of the monitored computer, thus, the information collected from a router is preferably different from the information collected from a user computer. For example, data collection probes 200 may optionally be implemented to communicate with one or more third party active monitoring systems and/or software (not shown), such as third party control and monitoring systems, including but not limited to systems from Precise, CA, or others.

These third party control and monitoring systems preferably install agents inside one or more computers 102 (more preferably in servers), and collect data to provide aggregated information and/or basic monitoring alerts once an actual decrease in performance, loss of function and/or outright failure has occurred. Data collection probes 200 optionally receive such data from the third party system which has already been installed on network 104 (not shown), preferably configured according to the API (application programming interface) for the third party system as is known in the art, such as SNMP (Simple Network Management Protocol), for example. Data is optionally and preferably periodically queried from the third party system.

Monitor 106 also optionally and preferably comprises a main system initiator module 202 for activating data collection probes 200 and for controlling one or more activities of data collection probes 200, more preferably with regard to the third party system described above.

Monitor 106 also optionally and preferably comprises a database communication module 204 for communicating with database 110 for reading configuration data and for storing collected data. Predictor 108 also optionally and preferably communicates with database 110 through monitor 106.

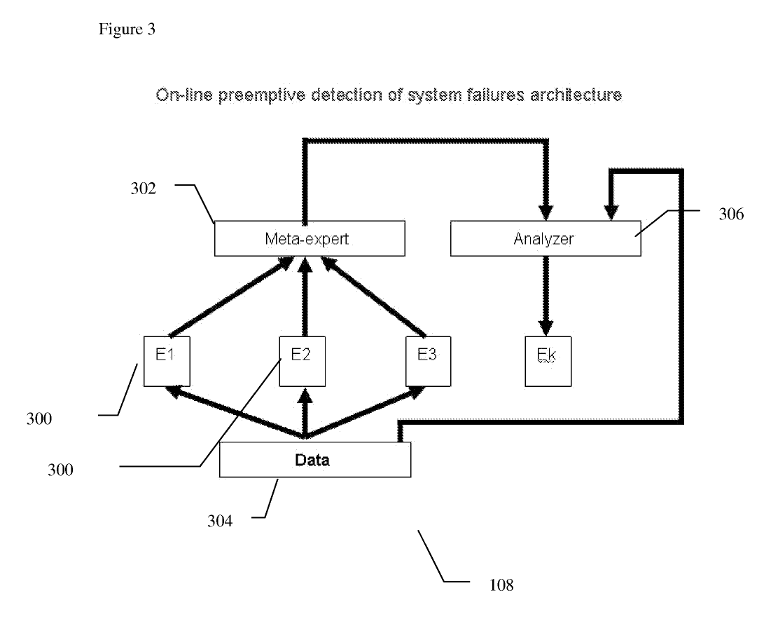

Monitor 106 also optionally and preferably comprises a rules base 208 for storing a plurality of rules with regard to behavior of data collection probes 200, including how they are permitted to interact with the third party software, for example according to when to send a query and/or how frequently to send queries. In addition to or in place of one or more rules, one or more scripts and/or compiled software code may optionally be implemented. The information retrieved from the monitor is optionally and preferably transferred to data cleaner 140 for filtering out the noise from the data, which may optionally be collected as part of the general data being obtained from network 104. The filtered information is kept in the database 110 to be used by predictor 108 and for purposes of analysis. Data stored in database 110 is used by predictor 108 in order to predict the behavior of the system. The behavior of predictor 108 is described in more detail in FIG. 3.

FIG. 3 is a schematic block diagram of an exemplary, illustrative hierarchical predictive system according to some embodiments of the present invention. As shown, predictor 108 optionally and preferably features a plurality of models 300, shown as E1, E2, E3 etc; any number of models 300 may optionally be featured. Models 300 operate in run time according to the filtered data 304 which is kept in database 110. This data 304 in database 110 contains information regarding actual behavior of the computer network, more preferably including actual performance data, as shown with regard to is data 304. The actual performance data may optionally comprise data from at least one computer on the network but more preferably comprises data from a plurality of computers which interact through the network.

Each model 300 optionally and preferably operates according to one of a plurality of algorithms, including but not limited to neural networks, regression trees, robust linear regression, nearest-neighbor estimation and so forth.

The output of models 300 is preferably combined by a meta-expert 302 at a higher level of the hierarchy as shown. The hierarchy within predictor 108 may optionally comprise any number of levels, although only two are shown for the sake of clarity and without any intention of being limiting in any way. The meta expert 302 preferably takes into consideration the accuracy of the prediction of the models 300 which is determined in the learning (offline) phase. The combined output is calculated based on algorithms such as weighted median rule, weighted average and the like. The combined output may optionally and preferably be used to at least predict a trend toward reduced performance of the computer network for example, although more preferably it is used to predict actual reduced performance and/or a potential failure. Alerts regarding predicted failure are preferably generated based on predicted results. User can then view system data 304 (both original data and filtered data) and analyze the behavior of the system when prediction occurs.

An analyzer 306 optionally and preferably is activated in learning (offline) phase also analyzes data 304 in order to create at least one new model 300, shown as Ek. Analyzer 306 preferably analyzes behavior of each model 300 by periodically activating the models based on historical data which was collected by probes 200 and is kept in database 110. Each model 300 is preferably activated with different historical data. The output of each model is preferably compared to real data which is also kept in database 110. For example, model 300 might predict three seconds response time, while the actual response time is one second. Analyzer 306 also optionally and preferably prunes or removes model 300 which fails to meet a minimum threshold of predictive accuracy, for example by comparing the bias of prediction values from real values to a threshold.

Analyzer 306 optionally and preferably adds more models by selecting additional algorithms from a plurality of available algorithms. Each model preferably implements one algorithm. Examples of such algorithms include but are not limited to algorithms based upon a regression tree, robust linear regression and nearest-neighbor estimation. Analyzer 306 preferably creates the new model 300 in order to cover at least one aspect of the functional and/or statistical space which is not covered by existing models 300.

One non-limiting, illustrative example of a method for creating at least one new model 300 is given as follows. Model 300 is optionally constructed to use the output of a robust regression algorithm, such as a linear regression model for example. In this model, the variable of interest (such as the future response rate of a transaction between two computers on the network) is predicted as a linear combination of the current variables. Unlike the classic linear regression algorithm, in robust regression the parameter vector is constructed in a way that does not assume a Gaussian distribution, and hence is less sensitive to the problem of extremely rare events, which may cause a non-Gaussian distribution (i.e., a long-tail). The algorithm may optionally be implemented according to the version supplied in Matlab for example.

Each model 300 may optionally and preferably be improved through the use of one or more data cleaning techniques, to process the data before it is analyzed for incorporation into model 300. Currently, techniques that are used to smooth or “clean” the data typically undershoot or oversmooth the measured signal. The present invention, in some embodiments, provides a method for cleaning the data without undersmoothing or oversmoothing the data. The data cleaning model first model the signal, using a complex Bayesian model that incorporates non-linear and heavy-tail transition probabilities characterized by a jump-diffusion process. The prior distribution is Gaussian, while the transition is optionally a mix between Gaussian and Cauchy distribution (also known as the Cauchy-Lorentz distribution or simply Lorentz distribution). The first is responsible for the diffusion process, while the latter is responsible for abrupt jumps. In addition, the transition optionally and preferably incorporates one or more components providing a jump-back, so that the jumps optionally are maintained in pairs (for example, if the data optionally changes abruptly in one direction and then again changes abruptly in a second direction, which may comprise a return to the initial data state, or a to a data state similar to the initial data state; the jump-back enables both the initial change and the return to the initial data state or to a similar state). The posterior state distribution is simulated using a variation of particle-filtering algorithm, in which the distribution is approximated by a large collection of “particles” that are propagated using a discredited jump-diffusion process. The simulation is optionally and preferably performed according to a Monte Carlo simulation, where the collection of particles represents posterior distribution at every time slice. The particles are described by a position and Gaussian momentum variable and the population is propagated from time ‘t’ to time ‘t+1’ using the transition probability described above.

When several measured variables are known to be strongly correlated, the correlation can be incorporated into the model, to allow additional noise reduction. By “correlation” it meant simple linear correlation between the variables. Correlation is incorporated into the model by introducing coupling terms between position/momentum of the correlated variables.

The above method may optionally be applied for preprocessing data before presenting is to the user and/or preprocessing data before feeding it into the prediction module 108.

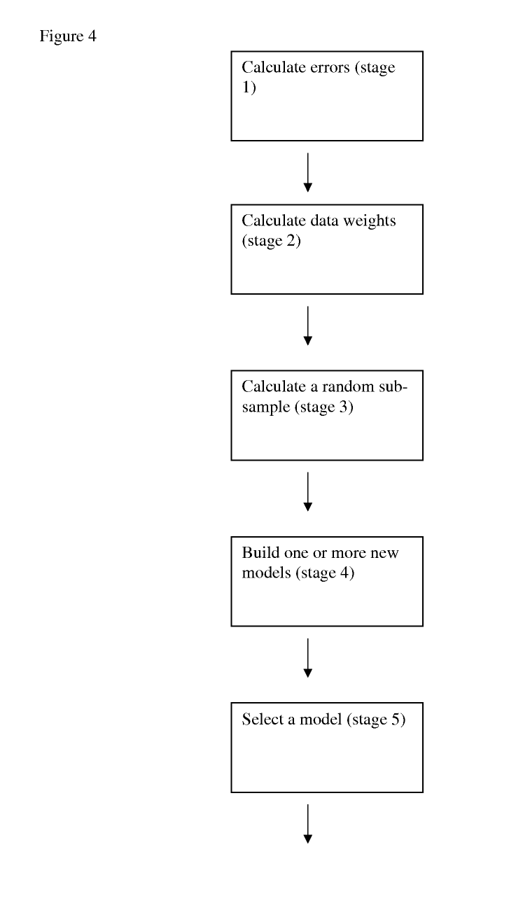

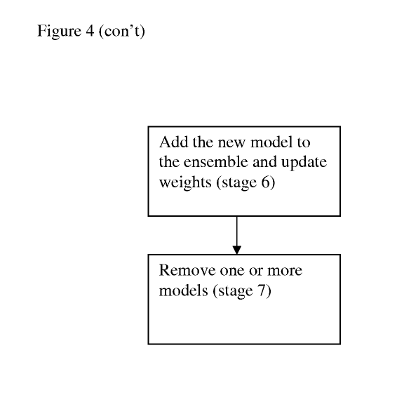

FIG. 4 shows an exemplary, illustrative method according to some embodiments of the present invention for the function of a pruning operator.

The stages are also described below with regard to various formulae. If D={ d̅ᵢ=( x̅ᵢ,yᵢ)}, then in stage 1 errors are calculated according to the following equations:

$${e}_{i} = {err}_{ensemble} ( {\overline{d}}_{1} ) ; Loss ( D ) = \frac{1}{n} \sum {e}_{i}$$

Stages 2 to 7 may optionally be repeated at least once and/or until a desired threshold of accuracy is met. In stage 2, the data weights wᵢ are preferably calculated as a function of Loss(D) and eᵢ

In stage 3, a random sub-sample \hat{D} based on the data weights is calculated from D.

In stage 4, one or more new models are preferably built using \hat{D} and one or more learning algorithm(s).

In stage 5, a model is selected, optionally either randomly or based on one of the model comparison criteria.

In stage 6, the new model is added to the ensemble and the model weights are preferably updated accordingly.

In stage 7, preferably one or more models with a weight below a minimum threshold are removed.

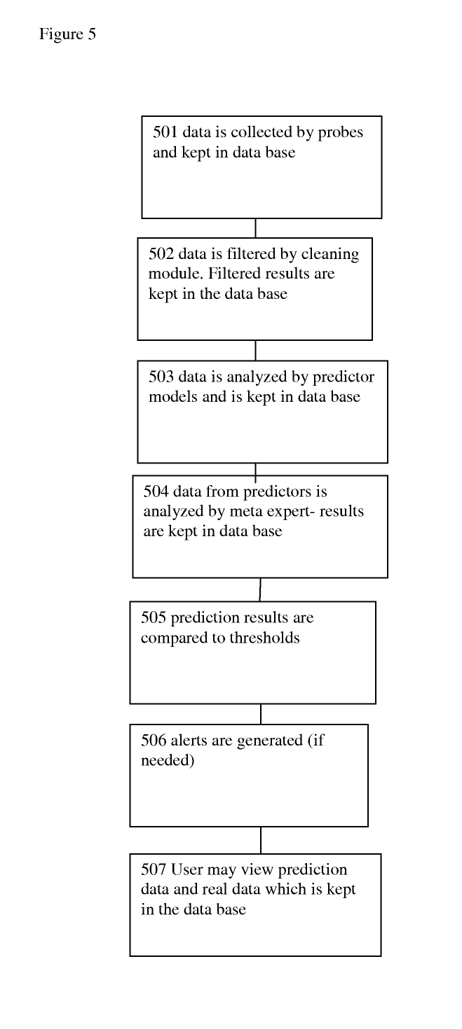

FIG. 5 is an exemplary scenario of real time behavior of an exemplary system. The system preferably and periodically collects data from computers in the network, stores the data in the data base, and operates predictor models based on filtered data. The result of the predictor models is preferably combined and analyzed by the meta expert, test results are compared to threshold and, if a threshold is exceeded, one or more alarms are preferably generated to warn about the predicted problem. The information regarding the status of computers in the network and the status of network at the time the prediction took place is available to the user, preferably over HTTP.

In the drawing: first data from computers and the computer network is preferably collected by probes and kept in database (501). Next data is optionally and preferably filtered by cleaning module as explained in more details in FIG. 5 (502). Next data is analyzed by predictor models and is is kept in database (503). Each predictor model performs its own decisions based on the algorithm performed by this model. Next the meta expert preferably analyzes data from all models while taking into consideration the weight of each model. Results are kept in data base (504). Next the prediction results are compared to threshold values to find out if a fault is predicted (505). The thresholds are preferably defined by the user via rule manager module, although they may optionally be calculated automatically. Next if predicted values exceed threshold, alerts are generated (506). At any time user can view prediction data and real data, preferably via HTTP interface. When alert occurs, the user can view information potentially relevant to this particular problem which was collected by the system in order to facilitate later analysis of the problem (507).

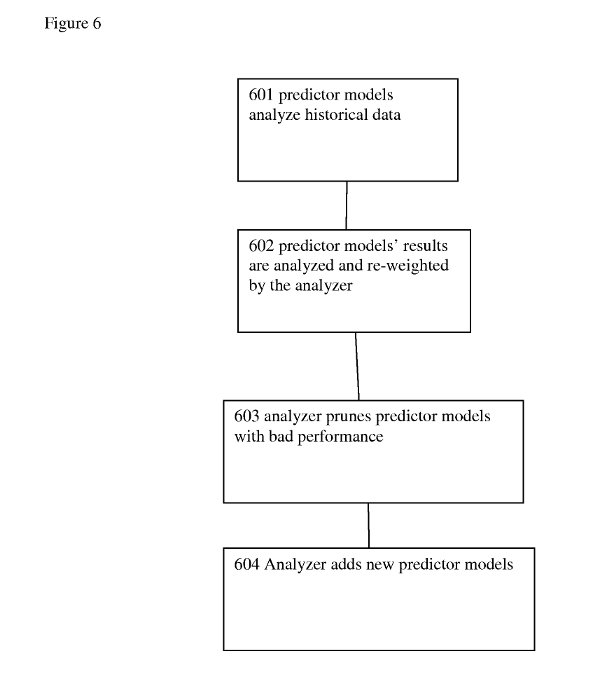

FIG. 6 is an exemplary description of learning process. Learning process is done periodically in order to improve the accuracy of real time prediction. Learning process is preferably done offline, using real data stored in the data base. This process preferably activates the prediction models and compares the prediction results with real values which are preferably stored in data base. Each model is preferably weighted according to the accuracy of its prediction results. Models with low accuracy are preferably pruned while new models representing new prediction algorithms are preferably generated.

In the drawing: first each predictor model preferably analyzes historical data (601). Next the analyzer model preferably analyzes predictor results, preferably by comparing them to real values stored in data base (602). Next, optionally an exemplary weighted algorithm is used for weighting the models. The weight alpha^{t}^{ₖ} of model mₖ at stage t is calculated as a function of error of model mₖ with respect to one or more datasets alpha^{t}^{ₖ}=F(E^{t}^{ₖ}). One particular function “F(.)” that may optionally be used is F(x)=−log(x/(1−x)).

Errors are preferably calculated according to the following options—model mₖ with respect to the latest dataset Dₜ, or alternatively, evaluate each model mₖ with respect to the dataset it was created for (Dₖ), or alternatively is average the error of model eₖ with respect to several datasets. Next predictors with bad performance (low accuracy) are preferably pruned by the analyzer (603). Next one or more new models are optionally and preferably added by analyzer (604).

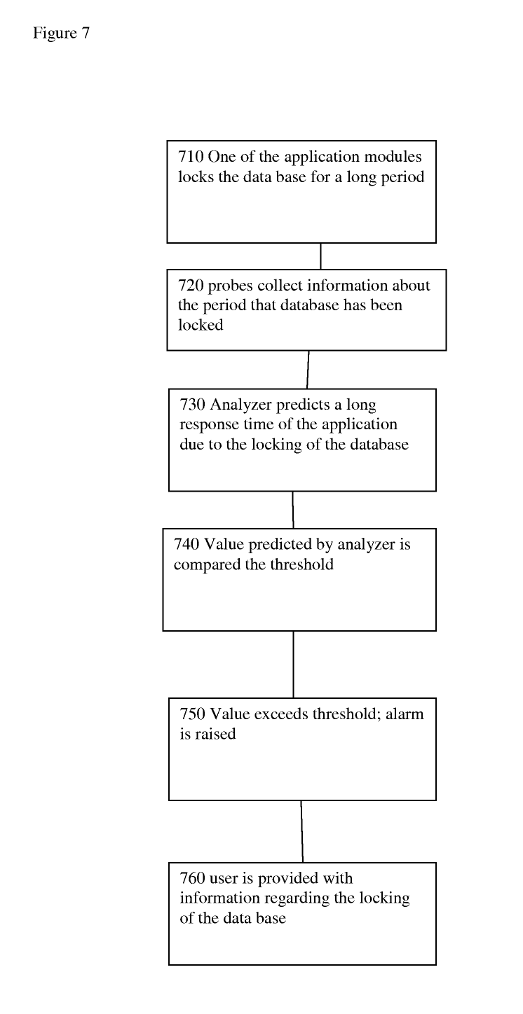

FIG. 7 is an exemplary scenario which emphasizes the importance and benefits of the system. In the exemplary environment there is a plurality of application servers and a plurality of database servers. There is a possibility that an application server locks certain database tables for access while finishing its working with the database. Locking the database for a period longer than its regular work time causes the other application servers to operate more slowly. As a result memory utilization is raised. Eventually, there is no free memory left, and no new objects are able to initiate, which leads to a significant drop in CPU utilization. The system and method of the present invention, in some embodiments, preferably overcome the deficiency of analyzing the cause of the memory usage and dropping in CPU utilization, by preferably alerting when the locking of database for a long period occurs by providing information about the situation and by locating the application that initiated the locks. In the drawing:

One of the application modules optionally locks the data base for a long period (710). A probe that has collected information from database reports the period of time database has been locked (720). Analyzer analyses the information received from probes and in particular the information regarding the long period in which database has been locked. The result predicts a long response time in the application due to the problem in database (730). Value predicted by analyzer is compared to threshold (740). The value (of application response time) exceeds threshold and, thus, an alarm is raised (750). User, who is alerted by the alarm, analyses the information which includes details about the locking period of the database and the application that is responsible for locking the database and is able to avoid the trend in the future (760).

While the invention has been described with respect to a limited number of embodiments, it will be appreciated that many variations, modifications and other applications of the invention may be made.

1. A method for at least predicting a trend toward reduced performance of a computer network, comprising:
Modeling behavior of the computer network; and
Predicting the trend according to said modeled behavior.

2. The method of claim 1, wherein said modeling comprising:
Determining a plurality of potential models for said behavior; and
Predicting the trend from said plurality of potential models.

3. The method of claim 2, wherein said predicting further comprises:
Combining predictions from said plurality models to form a combination to predict the trend.

4. The method of claim 3 wherein said combination is composed of weighted models.

5. The method of claim 4 wherein said weighted model affects said combination result according to its weight.

6. A method for improving accuracy of predicting a trend toward reduced performance of a computer network, comprising:
Weighting each model according to accuracy of prediction;
Removing at least one potential model according to at least one criterion; and
Adding at least one potential new model.

7. The method of claim 1, wherein said behavior of the computer network comprises behavior of at least one computer on the computer network.

8. The method of claim 7, wherein said behavior of the computer network comprises behavior of a plurality of computers interacting through the computer network.

9. The method claim 8, further comprising:
Monitoring the computer network to obtain data regarding one or more functions of the network; and
Improving a predictive model according to said data.

10. The method of claim 9, wherein said monitoring further comprises cleaning the data to filter out the noise in the data.

11. The method of claim 10, wherein said cleaning the data further comprises constructing a complex Bayesian distribution; and reducing noise in the data according to correlation between a plurality of variables according to said distribution.

12. The method of claim 11, wherein said improving said predictive model comprises subjecting said predictive model to a learning period for processing historical data; and examining performance of said predictive model with real time data.

13. The method of claim 11, further comprising: issuing an alert if a predicted performance function of the network falls below or above a threshold.
